(19) United States
(12) Patent Application Publication
(10) Pub. No.: US 2024/0277135 A1
(43) Pub. Date: Aug. 22, 2024

(54) Chest mounted tool harness

(71) Applicant: Peter Cameron Mirkhani, New Milford, CT (US)

(72) Inventor: Peter Cameron Mirkhani, New Milford, CT (US)

(21) Appl. No.: 18/171,327

(22) Filed: Feb. 18, 2023

(51) Int. Cl. A45F 5/00; F16M 13/04

(52) U.S. Cl. CPC A45F 5/00; F16M 13/04; A45F 2200/0575

(57) ABSTRACT

The modular chest-mounted tool holder for handicapped people provides an innovative solution to the mobility and stability issues faced by persons missing a limb or having compromised ability in one limb. The harness is designed to be adjustable, comfortable, and easy to use, making it an ideal choice for individuals who require additional support and stability for the use of various tools that they would otherwise have considerable difficulty using. The modular tool holder provides an additional feature that can be useful for individuals who need to be able to use both hands while needing either a light or other instrument that would otherwise require the use of one hand. The invention has numerous potential applications for police, fire, EMS, as well as handicapped persons in the workplace.

### PRIOR ART

CA2893555C Adaptive arm support systems and methods for use

U.S. Pat. No. 9,682,471B2 Modular tool holder

U.S. Pat. No. 5,188,587A Active shoulder brace

### BACKGROUND OF THE INVENTION

Handicapped people with mobility impairments or limited use of their arms, often face difficulty in performing daily activities that involve lifting, reaching, carrying objects, or holding and using implements or tools due to their physical limitations. A chest harness designed to provide support and stability for otherwise unstable tools could be of great help to this population. Additionally, a modular tool holder can be useful for individuals who need to use various tools with them while performing tasks. As such, there is a need for a device that can securely hold tools and be easily accessed by individuals with disabilities.

### SUMMARY OF THE INVENTION

The present invention relates to a chest mounted tool holder that provides a secure and accessible means for individuals with disabilities to secure otherwise unstable tools. The device includes an articulated modular base, capable of accepting a plurality of holders, and an adjustable strap for securing the device to the chest of the disabled, weakened or handicapped individual.

### BRIEF DESCRIPTION OF DRAWINGS

FIG. 1 is a front perspective view of a right handed version of the chest mounted tool harness in accordance with the present invention, showing its primary components.

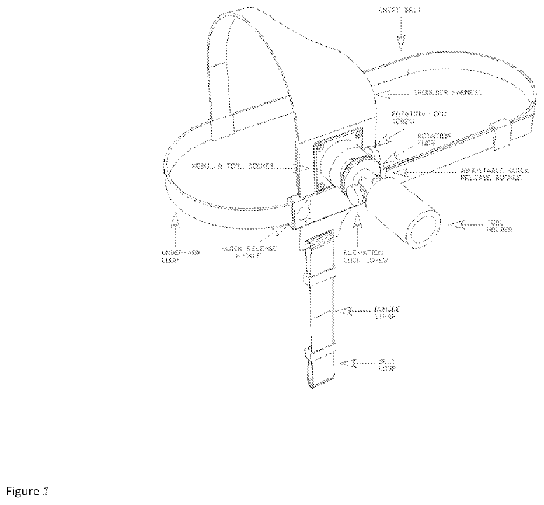

### DETAILED DESCRIPTION OF THE INVENTION

The shoulder harness is the primary support structure, composed of a semi-rigid polymer composite with limited flexibility. It supports the weight of the modular tool socket and any attached tools. It is lined with a breathable foam pad underneath for comfort.

The harness is kept from sliding via the use of the under-arm loop and the chest belt. Both the under-arm loop and chest belt are adjustable to fit a wide variety of body dimensions. Putting on and removal of the harness is facilitated by quick release buckles.

The harness is also prevented from torquing upwards with the use of a bungee strap that attaches to the individual's belt via a belt loop and/or clip.

The modular tool socket is a rigid fixture that is attached to the shoulder harness via screws or rivets. The socket is designed to accept a multiplicity of possible tools, such as flashlights, the handles of rakes, shovels, weed whackers, and other additional device specific tool holders.

The present implementation includes an adjustable tool holder capable of both rotational and angular adjustments. It is capable of having its orientation locked via thumb screws and also allows it to be stowed in a folded downward position. In one embodiment, the tool holder is also capable of limited telescoping, and can be fitted with a shock damping mechanism, like a spring or pneumatic/hydraulic damper, to reduce shocks to the chest and shoulder.

The chest mounted tool harness is specially useful for providing forward pressure against the chest such as in the use of a hammer drill with the proper adapter, where forward pressure is required. Or for example, with the handle of a snow shovel. Both examples leverage the upper body strength in those instances when the individual may be handicapped, weakened, or partially disabled and hence have limited ability to exert such required pressure with the use of their arms. Or for the use of such tools for persons with only one arm.

It also allows the use of tools such as flashlights to be affixed in any orientation from the chest, thus freeing the arms to perform various operations.

1. A modular chest-mounted tool holder, comprising;
An over-the-shoulder harness with under-arm straps, and vertical buckle strap,
A modular tool holder capable of accepting a plurality of different attachments for the use of various tools and implements, AND
A flexible tool holder capable of rotation and tilt to allow for tool orientation.

2. The modular chest mounted tool holder of claim 1, wherein the unique tool holding position is on the chest, allowing for the use of upper body strength to provide forward pressure.

3. The modular chest mounted tool holder of claim 1, wherein the modular tool holder allows for a multitude of adjustable orientations both flexibly and capable of being fixed in place.
